(19) United States
(12) Patent Application Publication
(10) Pub. No.: US 2011/0279684 A1
(43) Pub. Date: Nov. 17, 2011

(54) SIGNAL PROCESSING DEVICE AND SIGNAL PROCESSING METHOD

(75) Inventors: Takuto MOTOYAMA, Tokyo (JP); Toshinori Ihara, Tokyo (JP)

(73) Assignee: Sony Corporation, Tokyo (JP)

(21) Appl. No.: 13/080,284

(22) Filed: Apr. 5, 2011

(30) Foreign Application Priority Data
May 14, 2010 (JP) 2010-112273

(51) Int. Cl. H04N 17/00

(52) U.S. Cl. 348/181; 348/E17.001

(57) ABSTRACT

There is provided a signal processing device including a measured value acquisition unit configured to acquire a measured value for a feature quantity, the feature quantity having an influence on an estimation of a motion that appears in each frame of an input video signal, a determination unit configured to, on the basis of the measured value acquired by the measured value acquisition unit, determine a characteristic of a filter to be applied to the input video signal, and a filtering unit configured to generate a video signal for use in the estimation of a motion by applying to the input video signal a filter with the characteristic determined by the determination unit.

### BACKGROUND OF THE INVENTION

1. Field of the Invention

The present invention relates to a signal processing device and a signal processing method.

2. Description of the Related Art

There has been known a motion vector estimation technique as represented by a block matching method for estimating as a motion vector a motion of a person or an object that appears in each frame of a video signal. The estimated motion vector is used to, in interlace-to-progressive conversion or in frame rate conversion, for example, compensate for the motion and interpolate frames (or fields). The motion vector estimation technique is also a technique that is indispensable for the inter-frame prediction for increasing the compression efficiency in moving image compression coding. However, the motion vector estimation technique is typically susceptible to the influence of repetitive patterns or noise contained in a video signal. For example, when a single frame of a video signal contains a plurality of similar patterns, it would be difficult to accurately determine to which of the plurality of similar patterns a given pattern in the previous frame has moved.

Referring to FIG. 17, there is shown an example of a frame Im01 at time T (shown to the left) and a frame Im02 at time T+Δt (shown to the right). The frame Im01 contains a block B1 having a repetitive pattern shown by striped hatching. Meanwhile, the frame Im02 contains blocks B2 and B3 each having a repetitive pattern shown by striped hatching. When the block matching method is applied to such an input video signal, it follows that the correlation between the block B1 and the block B2 is substantially equal to that between the block B1 and the block B3. Therefore, the block B1 at time T could be construed as either having moved to the bock B2 or to the block B3 at time T+Δt.

As a result, when a video signal contains a number of high-frequency repetitive patterns or noise, the directions of motion vectors that should be guided for individual pixels could differ in various ways as a number of similar patterns exists within the same frame. This could result in an image corruption due to errors such as variations in the vectors. That is, as errors in the motion vectors can frequently occur, there is a problem that a user may sense that an image may become corrupted after frames are interpolated thereto, for example.

As a method for reducing such errors in the motion vectors, JP 2009-266170A proposes a method of comparing a motion vector, which has been calculated, with the neighboring vectors and correcting the vector in such a manner as to suppress spatial or temporal variations in the vectors. In addition, in the field of MPEG (Moving Picture Experts Group) compression, there is known a method of adaptively applying a low-pass filter to an input video signal in accordance with the content of the input video signal, thereby suppressing noise components such as mosquito noise (for example, see JP 2001-231038A)

### SUMMARY OF THE INVENTION

However, the method proposed in JP 2009-266170A requires a number of vectors, which has been calculated in the past, to be stored for later comparison purposes, and thus requires resources such as large frame memory. Therefore, it has been impossible with this technique to meet the demand for size and cost reduction of devices, for example. Further, while noise components can be suppressed with a method of filtering an input video signal such as the one disclosed in JP2001-231038A, this technique cannot simply be applied to an estimation of a motion vector. For example, if a low pass filter is applied to a video signal, the image quality (e.g., sharpness) of an output video could degrade depending on the strength of the filter. If one aims to estimate a motion vector, however, it would be only necessary that components that can cause errors be removed from information that serves as a basis for the estimation of a motion vector. Nevertheless, it should be avoided to influence the image quality of an output video. Components that can cause errors are, for example, high-frequency components of a video signal that contains a number of high-frequency repetitive patterns or noise. In such a case, it is expected that a more favorable estimation result can be obtained by estimating a motion vector after extracting or relatively emphasizing the low-frequency components.

In light of the foregoing, it is desirable to provide a novel and improved signal processing device and signal processing method that can provide a video signal for estimating a motion, which appears in each frame of an input video signal, with higher accuracy without influencing the image quality of an output video.

According to an embodiment of the present invention, there is provided a signal processing device including a measured value acquisition unit configured to acquire a measured value for a feature quantity, the feature quantity having an influence on an estimation of a motion that appears in each frame of an input video signal, a determination unit configured to, on the basis of the measured value acquired by the measured value acquisition unit, determine a characteristic of a filter to be applied to the input video signal, and a filtering unit configured to generate a video signal for use in the estimation of a motion by applying to the input video signal a filter with the characteristic determined by the determination unit.

According to the aforementioned configuration, the characteristic of a filter to be applied to an input video signal is determined on the basis of a measured value for a feature quantity, which has an influence on an estimation of a motion that appears in each frame of the input video signal, and a filter with the thus determined characteristic is applied to the input video signal. Then, a video signal generated as a result of the filtering process is used for the estimation of a motion.

The feature quantity having an influence on the estimation of a motion may include a feature quantity depending on an amplitude of a high-frequency component in a horizontal direction or a vertical direction of each frame of the input video signal.

The feature quantity depending on the amplitude of the high-frequency component may include a first feature quantity representing a histogram per band of the horizontal direction or the vertical direction of each frame of the input video signal.

The feature quantity depending on the amplitude of the high-frequency component may include a second feature quantity representing a sum of differences between pixel values of adjacent pixels that are contained in each frame of the input video signal.

The determination unit may change an attenuation level for a high-frequency band as the characteristic of the filter in accordance with the amplitude of the high-frequency component in each frame of the input video signal, the amplitude being indicated by the measured value acquired by the measured value acquisition unit.

The determination unit may change a blocked band as the characteristic of the filter in accordance with a frequency of a band that indicates the maximum frequence in the histogram per band.

The feature quantity having an influence on the estimation of a motion may include a third feature quantity depending on an intensity of a noise component contained in each frame of the input video signal.

The characteristic of the filter may be represented by a filter coefficient to be multiplied by each signal value of the input video signal, and a shift amount for each signal value. The determination unit may change the shift amount in accordance with the intensity of the noise component in each frame of the input video signal, the intensity being indicated by the measured value acquired by the measured value acquisition unit.

The signal processing device may further include a measuring unit configured to measure the feature quantity for each frame of the input video signal.

The signal processing device may further include a motion estimation unit configured to estimate a motion that appears in each frame on the basis of a signal correlation between a first frame and a second frame of the video signal generated by the filtering unit.

The signal processing device may further include an interpolation processing unit configured to interpolate another frame between the first frame and the second frame of the input video signal in accordance with a motion estimated by the motion estimation unit.

According to another embodiment of the present invention, there is provided a signal processing method for processing an input video signal with a signal processing device, the method including the steps of acquiring a measured value for a feature quantity, the feature quantity having an influence on an estimation of a motion that appears in each frame of the input video signal, determining a characteristic of a filter to be applied to the input video signal on the basis of the acquired measured value, and generating a video signal for use in the estimation of a motion by applying to the input video signal a filter with the determined characteristic.

As described above, according to the signal processing device and the signal processing method in accordance with the present invention, it is possible to provide a video signal for estimating a motion, which appears in each frame of an input video signal, with higher accuracy without influencing the image quality of an output video.

### BRIEF DESCRIPTION OF THE DRAWINGS

FIG. 1 is a block diagram showing an example of the overall configuration of a signal processing device in accordance with one embodiment;

FIG. 2 is a block diagram showing an example of a more detailed configuration of a measuring unit in accordance with one embodiment;

FIG. 3 is a block diagram showing an example of a more specific configuration of a band measuring unit in accordance with one embodiment;

FIG. 4 is a block diagram showing an example of a more specific configuration of an adjacent difference measuring unit in accordance with one embodiment;

FIG. 5 is a block diagram showing an example of a more specific configuration of a noise measuring unit in accordance with one embodiment;

FIG. 6 is a block diagram showing an example of a more detailed configuration of a determination unit in accordance with one embodiment;

FIG. 7A is an explanatory diagram showing a first data example of a histogram per band;

FIG. 7B is an explanatory diagram showing a second data example of a histogram per band;

FIG. 8 is an explanatory diagram showing data examples of a strength selection table;

FIG. 9 is a flowchart showing an exemplary flow of a filter strength determination process performed on the basis of a histogram per band in accordance with one embodiment;

FIG. 10 is a flowchart showing an exemplary flow of a filter strength determination process performed on the basis of the sum of adjacent differences in accordance with one embodiment;

FIG. 11 is a block diagram showing an example of a more specific configuration of a characteristics determination unit in accordance with one embodiment;

FIG. 12 is a flow chart showing an exemplary flow of a strength step-control process in accordance with one embodiment;

FIG. 13 is an explanatory diagram for illustrating filter coefficients in accordance with one embodiment;

FIG. 14 is an explanatory diagram for illustrating an offset of the shift amount in accordance with one embodiment;

FIG. 15 is a block diagram showing an example of a more detailed configuration of a filtering unit in accordance with one embodiment;

FIG. 16 is a block diagram showing an exemplary configuration of a signal processing device in accordance with one variation; and

FIG. 17 is an explanatory diagram for illustrating the influence of a repetitive pattern contained in an input frame on an estimation of a motion vector.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The “DETAILED DESCRIPTION OF THE EMBODIMENTS” will be given in the following order.

1. Overall Configuration of a Signal Processing Device in Accordance with One Embodiment

2. Description of Each Part
2-1. Measuring Unit
2-2. Measured Value Acquisition Unit
2-3. Determination Unit
2-4. Filtering Unit
2-5. Frame Memory
2-6. Motion Estimation Unit
2-7. Interpolation Processing Unit

3. Description of the Advantageous Effects

4. Variation

<1. Overall Configuration of a Signal Processing Device in Accordance with One Embodiment>

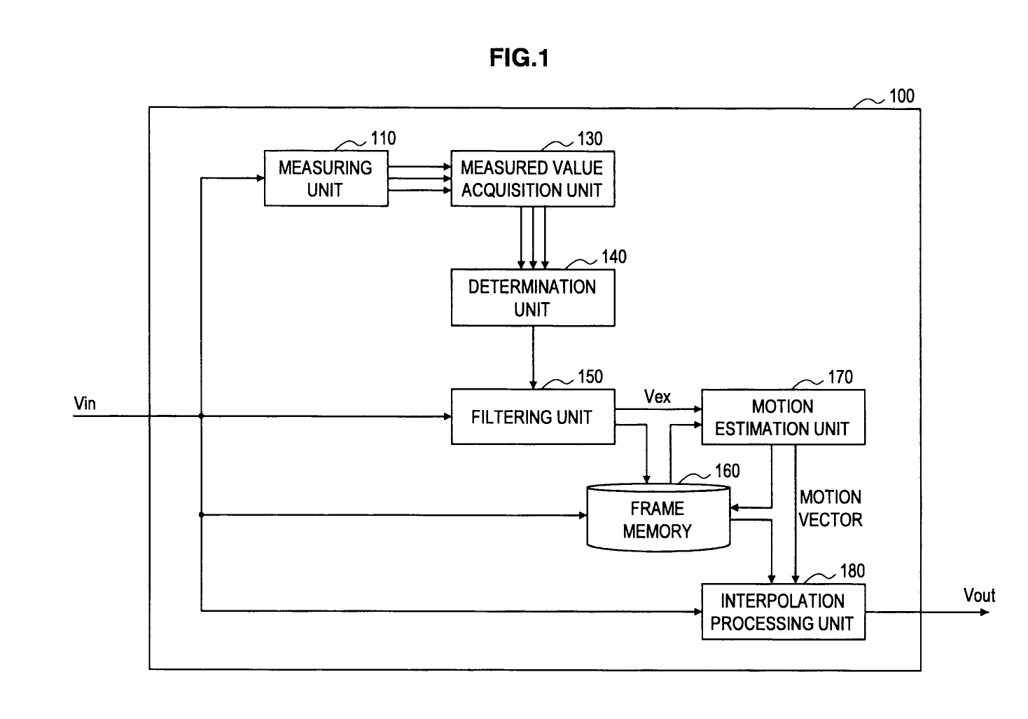

FIG. 1 is a block diagram showing an exemplary configuration of a signal processing device 100 in accordance with one embodiment of the present invention. Referring to FIG. 1, the signal processing device 100 includes a measuring unit 110, a measured value acquisition unit 130, a determination unit 140, a filtering unit 150, frame memory 160, a motion estimation unit 170, and an interpolation processing unit 180. The components other than the frame memory 160 of the signal processing device 100 can be implemented with a processor such as an integrated circuit like an ASIC (Application Specific Integrated Circuit), a system LSI (Large Scale Integration), or the like, or a CPU (Central Processing Unit), and with an auxiliary storage medium. The frame memory 160 can be implemented with a storage medium such as RAM (Random Access Memory) or flash memory.

In this embodiment, the signal processing device 100 acquires an externally input video signal Vᵢₙ, and processes the input video signal Vᵢₙ, and then outputs an output video signal Vₒᵤₜ with a frame(s) interpolated thereto. A motion vector, which is used for the interpolation of the frame(s) in the signal processing, is a vector that is estimated using a motion estimation video signal Vₑₓ. One advantage of the present invention is that the motion estimation video signal Vₑₓ is provided independently of the input video signal Vᵢₙ to which a frame(s) is/are interpolated. The following section will provide a more specific description of the configuration of each part of the signal processing device 100 that generates the aforementioned motion estimation video signal Vₑₓ, estimates a motion, and interpolates a frame(s).

### <2. Description of Each Part>

### [2-1. Measuring Unit]

The measuring unit 110 measures feature quantities that have an influence on an estimation of a motion that appears in each frame of the input video signal Vᵢₙ. The feature quantities measured by the measuring unit 110 in this embodiment include a feature quantity depending on the amplitude of high-frequency components in the horizontal direction and the vertical direction of each frame of the input video signal Vᵢₙ, and a feature quantity depending on the intensity of noise components contained in each frame of the input video signal Vᵢₙ. Further, the feature quantity depending on the amplitude of high-frequency components can include a histogram per band for the horizontal direction and the vertical direction of each frame of the input video signal Vᵢₙ, and a sum of the differences between the pixel values of adjacent pixels that are contained in each frame of the input video signal Vᵢₙ (hereinafter referred to as an “adjacent difference sum”).

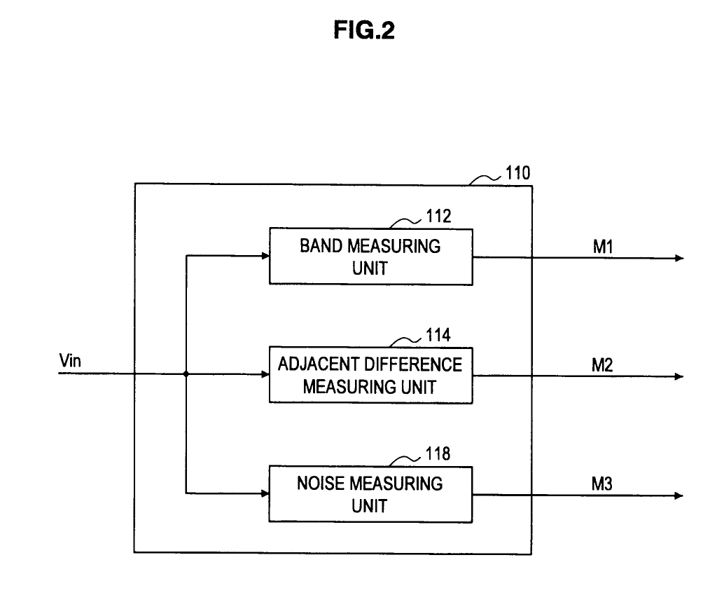

FIG. 2 is a block diagram showing an example of a more detailed configuration of the measuring unit 110 in accordance with this embodiment. Referring to FIG. 2, the measuring unit 110 includes a band measuring unit 112, an adjacent difference measuring unit 114, and a noise measuring unit 118. The input video signal Vᵢₙ input to the measuring unit 110 is input to each of the band measuring unit 112, the adjacent difference measuring unit 114, and the noise measuring unit 118. Then, the band measuring unit 112 outputs a histogram per band M1 for each frame as one of the aforementioned feature quantities. The adjacent difference measuring unit 114 outputs an adjacent difference sum M2 for each frame. The noise measuring unit 118 outputs a noise level M3 representing the intensity of noise components contained in each frame.

Note that the measuring unit 110 in other embodiments need not be configured to measure or output one or more of the aforementioned three types of the measured values: M1, M2, and M3. Further, the measuring unit 110 may be configured to measure feature quantities for one of the horizontal direction and the vertical direction of each frame of the input video signal Vᵢₙ.

### (Band Measuring Unit)

The band measuring unit 112 measures the intensities of repetitive components of the individual bands in the horizontal direction and the vertical direction of each frame of the input video signal Vᵢₙ, and generates a histogram per band for the horizontal direction and a histogram per band for the vertical direction. The intensities of repetitive components of the individual bands can be measured by using horizontal filters and vertical filters that are band-pass filters adapted to the individual bands.

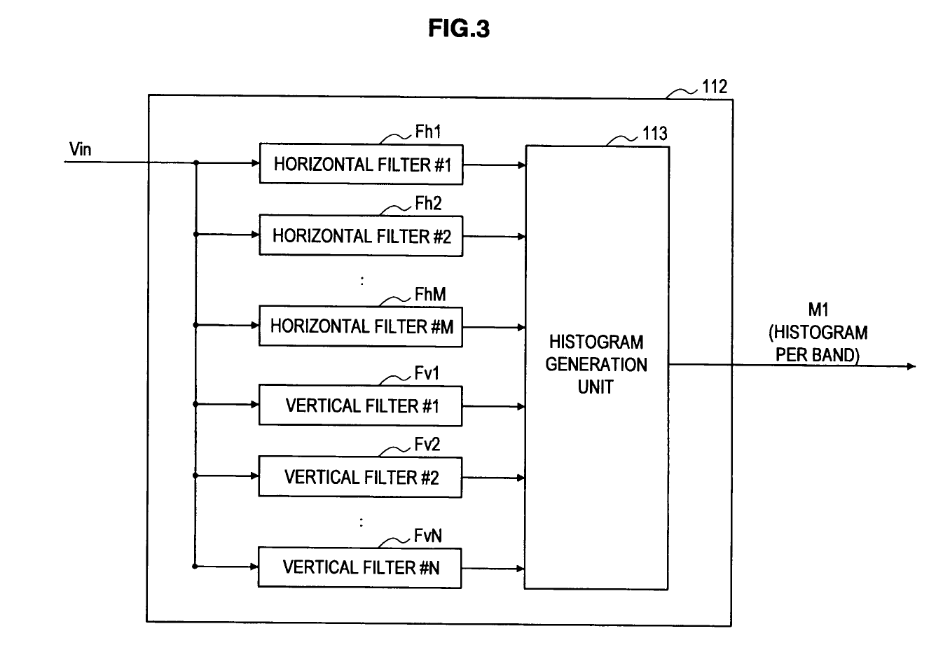

FIG. 3 is a block diagram showing an example of a more specific configuration of the band measuring unit 112 in accordance with this embodiment. Referring to FIG. 3, the band measuring unit 112 includes M horizontal band-pass filters Fh1 to FhM, N vertical band-pass filters Fv1 to FvN, and a histogram generation unit 113.

The first horizontal band-pass filter Fh1 separates the first band components in the horizontal direction of the input video signal Vᵢₙ. The second horizontal band-pass filter Fh2 separates the second band components in the horizontal direction of the input video signal Vᵢₙ. Likewise, the M-th horizontal band-pass filter FhM separates the M-th band components in the horizontal direction of the input video signal Vᵢₙ. That is, in this embodiment, repetitive components in the horizontal direction that are contained in a single frame are separated into M band components to be measured.

Meanwhile, the first vertical band-pass filter Fv1 separates the first band components in the vertical direction of the input video signal Vᵢₙ. The second vertical band-pass filter Fv2 separates the second band components in the vertical direction of the input video signal Vᵢₙ. Likewise, the N-th vertical band-pass filter FvN separates the N-th band components in the vertical direction of the input video signal Vᵢₙ. That is, in this embodiment, repetitive components in the vertical direction that are contained in a single frame are separated into N band components to be measured.

The histogram generation unit 113 integrates the amplitudes of the respective band components input from the horizontal filters Fh1 to FhM and the vertical filters Fv1 to FvN over a single frame to thereby generate a histogram per band M1. The histogram per band M1 includes the frequence of each of the M bands in the horizontal direction (an integrated value of the filter output) and the frequence of each of the N bands in the vertical direction.

### (Adjacent Difference Measuring Unit)

The adjacent difference measuring unit 114 measures the adjacent difference sum contained in each frame of the input video signal Vᵢₙ for each of the horizontal direction and the vertical direction.

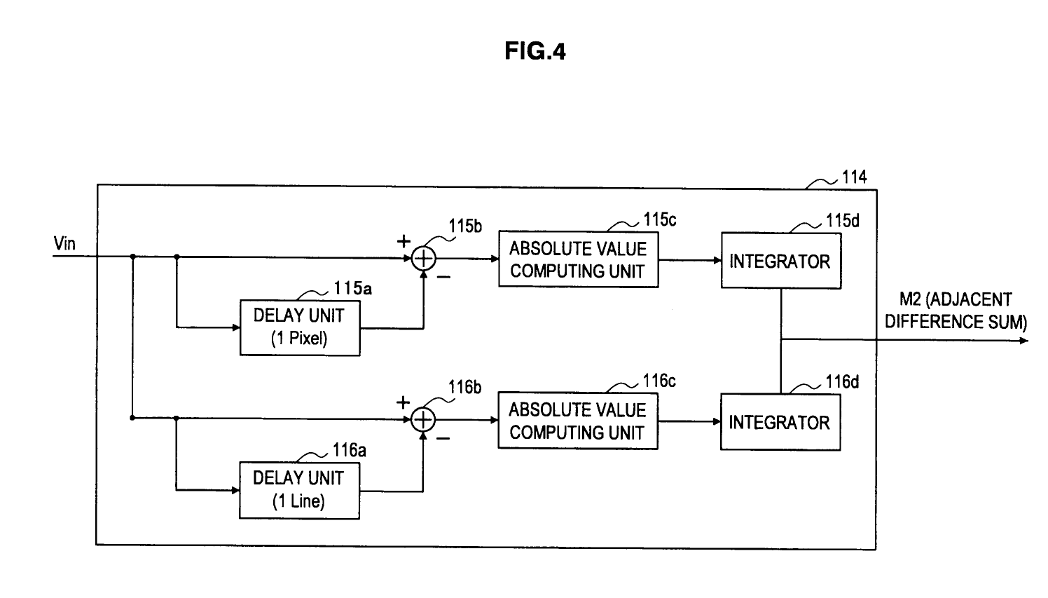

FIG. 4 is a block diagram showing an example of a more specific configuration of the adjacent difference measuring unit 114 in accordance with this embodiment. Referring to FIG. 4, the adjacent difference measuring unit 114 includes a delay unit 115a, a subtractor 115b, an absolute value computing unit 115c, and an integrator 115d; and a delay unit 116a, a subtractor 116b, an absolute value computing unit 116c, and an integrator 116d. Among these, the delay unit 115a, the subtractor 115b, the absolute value computing unit 115c, and the integrator 115d calculate the adjacent difference sum of the horizontal direction contained in each frame of the input video signal Vᵢₙ. Meanwhile, the delay unit 116a, the subtractor 116b, the absolute value computing unit 116c, and the integrator 116d calculate the adjacent difference sum of the vertical direction contained in each frame of the input video signal Vᵢₙ.

The delay unit 115a delays the timing of processing each pixel of the input video signal Vᵢₙ by one pixel (1 Pixel), and outputs the delayed pixel value to the subtractor 115b. The subtractor 115b calculates the difference between the pixel value of each pixel of the input video signal Vᵢₙ that has been input to the adjacent difference measuring unit 114 and the delayed pixel value input from the delay unit 115a. The absolute value computing unit 115c calculates the absolute value of the difference calculated by the subtractor 115b. Then, the integrator 115d integrates the absolute values of the differences calculated by the absolute value computing unit 115c over a single frame. Accordingly, the adjacent difference sum of the horizontal direction contained in each frame of the input video signal Vᵢₙ is calculated.

Meanwhile, the delay unit 116a delays the timing of processing each pixel of the input video signal Vᵢₙ by one line (1 Line), and outputs the delayed pixel value to the subtractor 116b. The subtractor 116b calculates the difference between the pixel value of each pixel of the input video signal Vᵢₙ that has been input to the adjacent difference measuring unit 114 and the delayed pixel value input from the delay unit 116a. The absolute value computing unit 116c calculates the absolute value of the difference calculated by the subtractor 116b. Then, the integrator 116d integrates the absolute values of the differences calculated by the absolute value computing unit 116c over a single frame. Accordingly, the adjacent difference sum of the vertical direction contained in each frame of the input video signal Vᵢₙ is calculated.

### (Noise Measuring Unit)

The noise measuring unit 118 measures a noise level that represents the intensity of noise components contained in each frame of the input video signal Vᵢₙ.

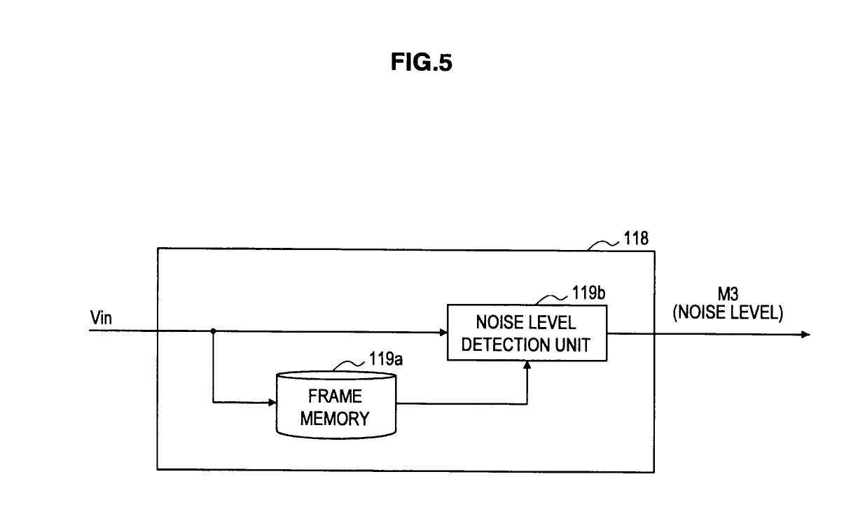

FIG. 5 is a block diagram showing an example of a more specific configuration of the noise measuring unit 118 in accordance with this embodiment. Referring to FIG. 5, the noise measuring unit 118 includes frame memory 119a and a noise level detection unit 119b.

The frame memory 119a temporarily stores each frame of the input video signal Vᵢₙ. The noise level detection unit 119b compares each frame of the input video signal Vᵢₙ with the previous frame stored in the frame memory 119a, and detects a noise level for each frame on the basis of the comparison result. Detection of a noise level with the level detection unit 119b is performed with a known method disclosed in, for example, JP 2009-3599A. The value of a noise level can be a value obtained by, for example, representing the amount of a standard deviation, variance, or the like using a predetermined number of bits (e.g., 10 bits).

The measuring unit 110 outputs to the measured value acquisition unit 130 the measured values as the measurement results obtained by the aforementioned band measuring unit 112, adjacent difference measuring unit 114, and noise measuring unit 118, that is, the histogram per band M1, the adjacent difference sum M2, and the noise level M3.

### [2-2. Measured Value Acquisition Unit]

The measured value acquisition unit 130 acquires from the measuring unit 110 the measured values for feature quantities that have an influence on an estimation of a motion that appears in each frame of the input video signal Vᵢₙ. In this embodiment, the measured values acquired by the measured value acquisition unit 130 are the aforementioned histogram per band M1, adjacent difference sum M2, and noise level M3. Then, the measured value acquisition unit 130 outputs the acquired measured values to the determination unit 140.

### [2-3. Determination Unit]

The determination unit 140 determines the characteristics of a filter to be applied to the input video signal Vᵢₙ on the basis of the measured values acquired by the measured value acquisition unit 130. A filter to be applied to the input video signal is a filter in the filtering unit 150 (described below). In this embodiment, the characteristics of a filter to be applied to the input video signal Vᵢₙ are represented by a filter coefficient to be multiplied by each signal value of the input video signal Vᵢₙ and a shift amount (also referred to as a “scaling parameter”) for each signal value. Thus, the determination unit 140 determines, on the basis of the measured values acquired by the measured value acquisition unit 130, a filter coefficient of a filter to be applied to the input video signal Vᵢₙ and the shift amount as described below.

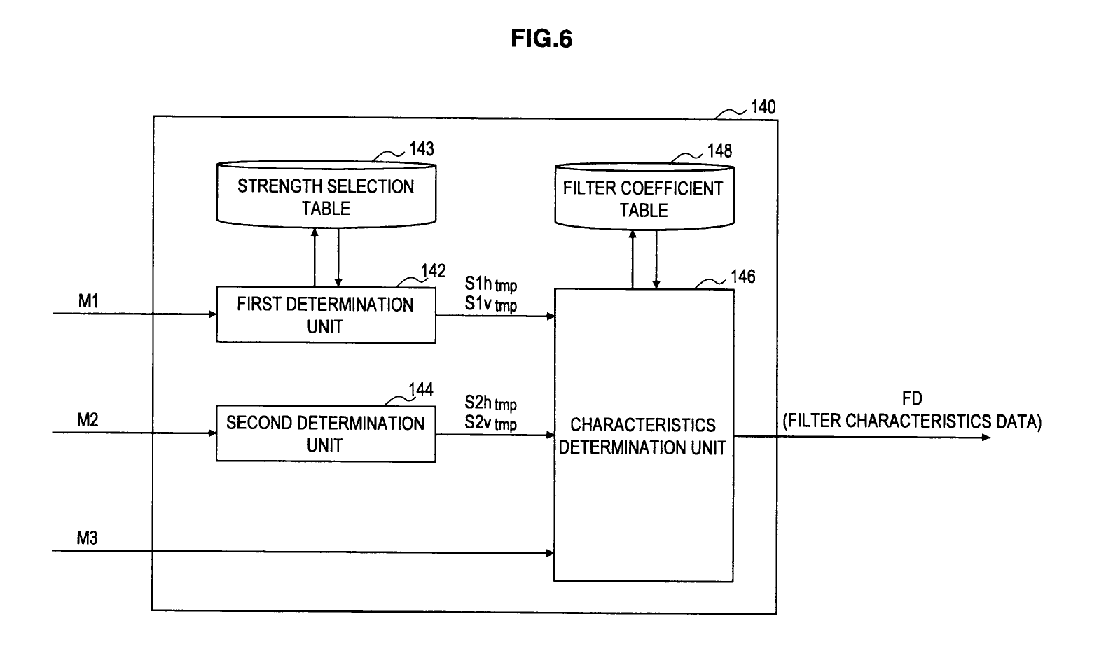

FIG. 6 is a block diagram showing an example of a more detailed configuration of the determination unit 140 in accordance with this embodiment. Referring to FIG. 6, the determination unit 140 includes a first determination unit 142, a strength selection table 143, a second determination unit 144, a characteristics determination unit 146, and a filter coefficient table 148. Among these, the first determination unit 142 and the second determination unit 144 each perform a process for changing the attenuation level for high-frequency bands, as the filter characteristics, in accordance with the amplitude of high-frequency components in each frame of the input video signal Vᵢₙ.

### (First Determination Unit)

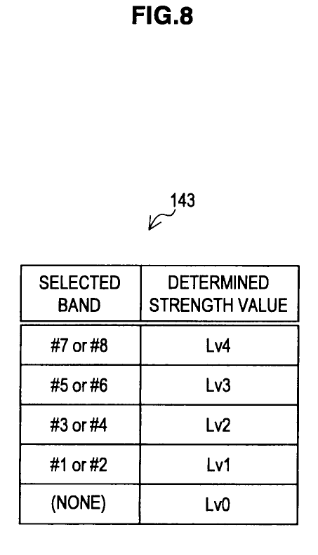

The first determination unit 142 changes the filter strength of the horizontal direction and the filter strength of the vertical direction to be applied to the input video signal Vᵢₙ in accordance with the histogram per band M1 input from the measured value acquisition unit 130. As used in this specification, “filter strength” refers to a concept that encompasses the attenuation level for an input signal and the width of the blocked bands. In the example shown in FIG. 8 described below, the filter strength is represented by any of the five following levels: Lv0 to Lv4. The filter strength is associated with a set of filter coefficients that includes a coefficient value for each filter tap. The set of filter coefficients substantially defines the attenuation level for an input signal and the width of the blocked bands.

More specifically, the first determination unit 142 selects a band that indicates the maximum frequence in the histogram per band for each of the horizontal direction and the vertical direction. Next, the first determination unit 142 compares the frequence of the selected band with a threshold. Herein, if the frequence of the selected band is higher than a predetermined threshold, it is determined that a repetitive pattern with that band is noticeable in the input frame. In this case, the higher the frequency of the selected band, the higher the filter strength that is selected by the first determination unit 142. Meanwhile, if the frequence of the selected band is not higher than the predetermined threshold, it is determined that repetitive patterns with none of the bands are very noticeable in the input frame. In that case, the first determination unit 142 selects the lowest filter strength.

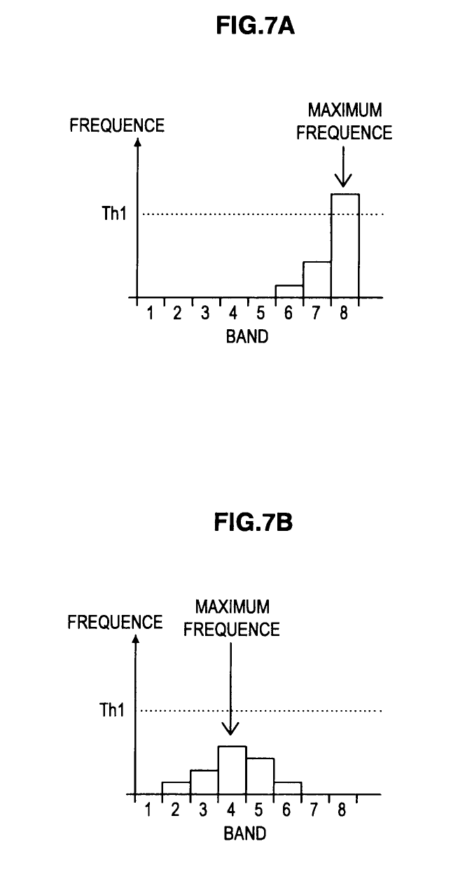

FIG. 7A and FIG. 7B are explanatory diagrams each showing data examples of the histogram per band.

Referring to FIG. 7A, the histogram per band includes frequences numbered one through eight that have been measured for eight bands. In the example of FIG. 7A, a band that indicates the maximum frequence is the eighth band, and the frequence of the eighth band is higher than a threshold Th1. In such a case, it is determined that a repetitive pattern with the frequency of the eighth band is noticeable in the input frame. Thus, the first determination unit 142 sets the filter strength in accordance with the frequency of the eighth band with reference to the strength selection table 143.

Meanwhile, in the example of FIG. 7B, a band that indicates the maximum frequence is the fourth band, and the frequence of the fourth band is lower than the threshold Th1. In such a case, it is determined that repetitive patterns with none of the frequencies are noticeable in the input frame. Thus, the first determination unit 142 selects the lowest filter strength.

FIG. 8 is an explanatory diagram showing data examples of the strength selection table 143. Referring to FIG. 8, the strength selection table 143 contains two data items that are a selected band and a determined strength value. The second row in the example of FIG. 8 shows that the filter strength can be set to the highest strength level Lv4 when the seventh (#7) or eighth (#8) band is selected as a band that indicates the maximum frequence. The third row shows that the filter strength can be set to the second strongest level Lv3 when the fifth (#5) or sixth (#6) band is selected as a band that indicates the maximum frequence. The fourth row shows that the filter strength can be set to the third strongest level Lv2 when the third (#3) or fourth (#4) band is selected as a band that indicates the maximum frequence. The fifth row shows that the filter strength can be set to the fourth strongest level Lv1 when the first (#1) or second (#2) band is selected as a band that indicates the maximum frequence. Noted that as described above, if the frequence of the selected band is below the threshold Th1, the first determination unit 142 sets the filter strength to be applied to the input video signal Vᵢₙ to the lowest strength level Lv0 regardless of the frequence of the band and the determined strength value in the strength selection table 143.

The first determination unit 142 performs the aforementioned filter strength determination process for each of the horizontal direction and the vertical direction. Then, the first determination unit 142 outputs to the characteristics determination unit 146 a filter strength S1hₜₘₚ of the horizontal direction and a filter strength S1vₜₘₚ of the vertical direction as the determination results. Note that the subscript “tmp” in the filter strengths S1hₜₘₚ and S1vₜₘₚ means that the filter strengths determined by the first determination unit 142 in this embodiment are temporary values. However, the present invention is not limited to this embodiment, and the filter strengths determined by the first determination unit 142 may be handled as the final values.

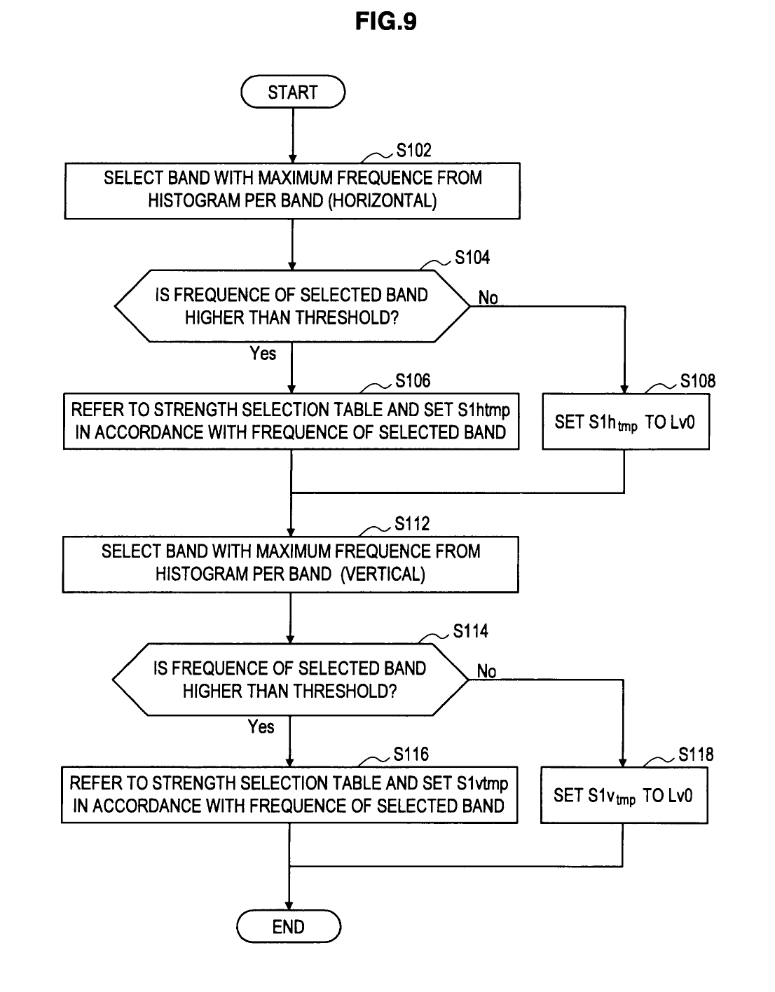

FIG. 9 is a flowchart showing an exemplary flow of the filter strength determination process of the first determination unit 142 in accordance with this embodiment.

Referring to FIG. 9, the first determination unit 142 first selects a band that indicates the maximum frequence from the histogram per band of the horizontal direction (sep S102). Next, the first determination unit 142 determines if the frequence of the selected band is higher than a predetermined threshold (S104). Herein, if the frequence of the selected band is determined to be higher than the predetermined threshold, the first determination unit 142 refers to the strength selection table 143, and sets the filter strength S1hₜₘₚ of the horizontal direction in accordance with the frequence of the selected band (step S106). Meanwhile, if the frequence of the selected band is not determined to be higher than the predetermined threshold in step S104, the first determination unit 142 sets the filter strength S1hₜₘₚ of the horizontal direction to the lowest level Lv0 (step S108).

Next, the first determination unit 142 selects a band that indicates the maximum frequence from the histogram per band of the vertical direction (step S112). Next, the first determination unit 142 determines if the frequence of the selected band is higher than a predetermined threshold (S114). Herein, if the frequence of the selected band is determined to be higher than the predetermined threshold, the first determination unit 142 refers to the strength selection table 143, and sets the filter strength S1vₜₘₚ of the vertical direction in accordance with the frequence of the selected band (step S116). Meanwhile, if the frequence of the selected band is not determined to be higher than the predetermined threshold in step S114, the first determination unit 142 sets the filter strength S1vₜₘₚ of the vertical direction to the lowest level Lv0 (step S118).

Note that the threshold compared with the frequence of the histogram per band of the horizontal direction in step S104 can be either the same value as or a different value from the threshold compared with the frequence of the histogram per band of the vertical direction in step S114.

### (Second Determination Unit)

The second determination unit 144 changes the filter strength of the horizontal direction and the filter strength of the vertical direction to be applied to the input video signal Vᵢₙ in accordance with the adjacent difference sum M2 input from the measured value acquisition unit 130. More specifically, the second determination unit 144 compares the adjacent difference sum M2 of each of the horizontal direction and the vertical direction with a predetermined threshold. If the value of the adjacent difference sum M2 is higher than the threshold, the second determination unit 144 selects the highest filter strength, while if the value of the adjacent difference sum M2 is not higher than the threshold, the second determination unit 144 selects the lowest filter strength. The second determination unit 144 performs such a filter strength determination process for each of the horizontal direction and the vertical direction. Then, the second determination unit 144 outputs to the characteristics determination unit 146 a filter strength S2hₜₘₚ of the horizontal direction and the filter strength S2vₜₘₚ of the vertical direction as the determination results.

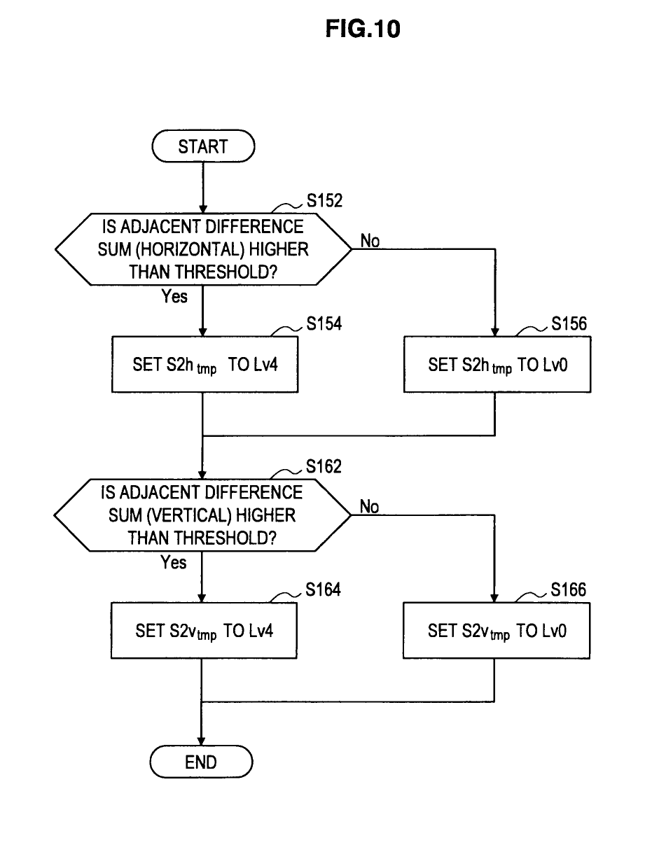

FIG. 10 is a flowchart showing an exemplary flow of the filter strength determination process of the second determination unit 144 in accordance with this embodiment.

Referring to FIG. 10, the second determination unit 144 determines if the adjacent difference sum of the horizontal direction is higher than a predetermined threshold (step S152). Herein, if the adjacent difference sum is determined to be higher than the predetermined threshold, the second determination unit 144 sets the filter strength S2hₜₘₚ of the horizontal direction to the highest level Lv4 (step S154). Meanwhile, if the adjacent difference sym is not determined to be higher than the predetermined threshold in step S152, the second determination unit 144 sets the filter strength S2hₜₘₚ of the horizontal direction to the lowest level Lv0 (step S156).

Next, the second determination unit 144 determines if the adjacent difference sum of the vertical direction is higher than a predetermined threshold (step S162). Herein, if the adjacent difference sum is determined to be higher then the predetermined threshold, the second determination unit 144 sets the filter strength S2vₜₘₚ of the vertical direction to the highest level Lv4 (step S164). Meanwhile, if the adjacent difference sum is not determined to be higher than the predetermined threshold in step S162, the second determination unit 144 sets the filter strength S2vₜₘₚ of the vertical direction to the lowest level Lv0 (step S166).

Note that the threshold compared with the adjacent difference sum of the horizontal direction in step S152 can be either the same value as or a different value from the threshold compared with the adjacent difference sum of the vertical direction in step S162.

### (Characteristics Determination Unit)

The characteristics determination unit 146 determines a filter coefficient of a filter in the horizontal direction to be applied to the input video signal Vᵢₙ on the basis of the filter strength S1hₜₘₚ of the horizontal direction input from the first determination unit 142 and the filter strength S2hₜₘₚ of the horizontal direction input from the second determination unit 144. The characteristics determination unit 146 also determines a filter coefficient of a filter in the vertical direction to be applied to the input video signal Vᵢₙ on the basis of the filter strength S1vₜₘₚ of the vertical direction input from the first determination unit 142 and the filter strength S2vₜₘₚ of the vertical direction input from the second determination unit 144. Further, the characteristics determination unit 146 determines a shift amount of a filter to be applied to the input video signal Vᵢₙ on the basis of the noise level M3 acquired from the measured value acquisition unit 130.

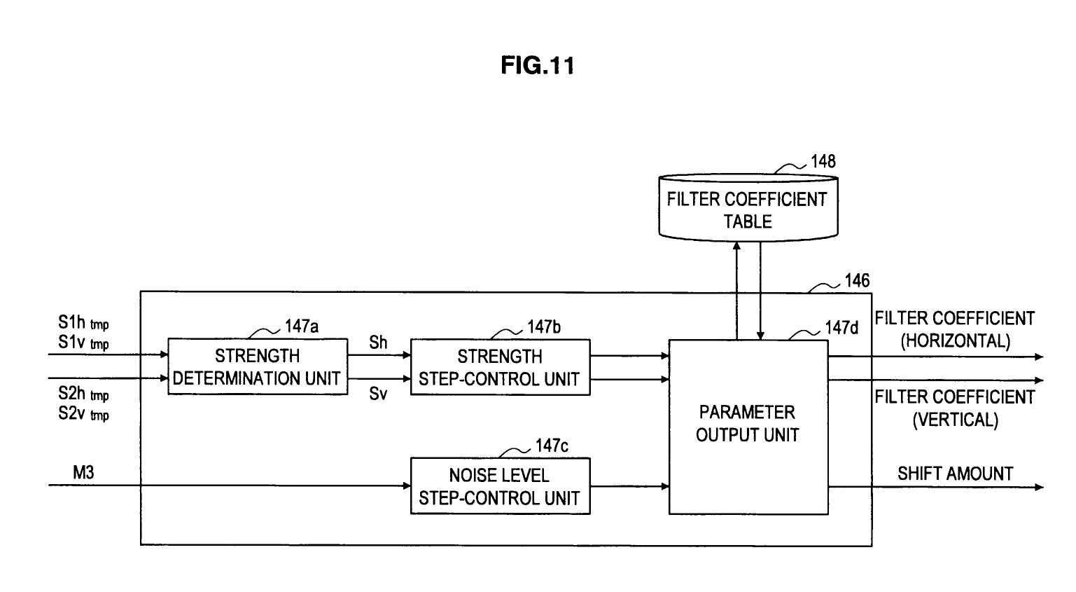

FIG. 11 is a block diagram showing an example of a more specific configuration of the characteristics determination unit 146 in accordance with this embodiment. Referring to FIG. 11, the characteristics determination unit 146 includes a strength determination unit 147a, a strength step-control unit 147b, a noise level step-control unit 147c, and a parameter output unit 147d.

### (1) Determination of the Filter Coefficient

The strength determination unit 147a calculates a single filter strength Sh from the filter strength S1hₜₘₚ of the horizontal direction input from the first determination unit 142 and the filter strength S2hₜₘₚ of the horizontal direction input from the second determination unit 144. The filter strength Sh can be a mean value of the filter strengths S1hₜₘₚ and S2hₜₘₚ. Alternatively, the filter strength Sh can be calculated by, for example, multiplying each of the filter strengths S1hₜₘₚ and S2hₜₘₚ by a predetermined weighting factor and averaging the weighted filter strengths S1hₜₘₚ and S2hₜₘₚ. Note that if the calculated mean value has fractions below the decimal point, such fractions can be rounded off, for example. Likewise, the strength determination unit 147a calculates a single filter strength Sv from the filter strength S1vₜₘₚ of the vertical direction input from the first determination unit 142 and the filter strength S2vₜₘₚ of the vertical direction input from the second determination unit 144. Then, the strength determination unit 147a outputs the thus calculated filter strengths Sh and Sv to the strength step-control unit 147b.

The strength step-control unit 147b controls the output value of the strength such that the filter strength changes in a stepwise manner to prevent a vector error that may otherwise occur due to an abrupt change in the filter strength. For example, the strength step-control unit 147b, if the output value of the strength of the previous frame is Lv0 and the latest strength input from the strength determination unit 147a is Lv4, controls the output value of the strength on a frame-by-frame basis such that the strengths output to the parameter output unit 147d are Lv0→Lv1→Lv2→Lv3→Lv4.

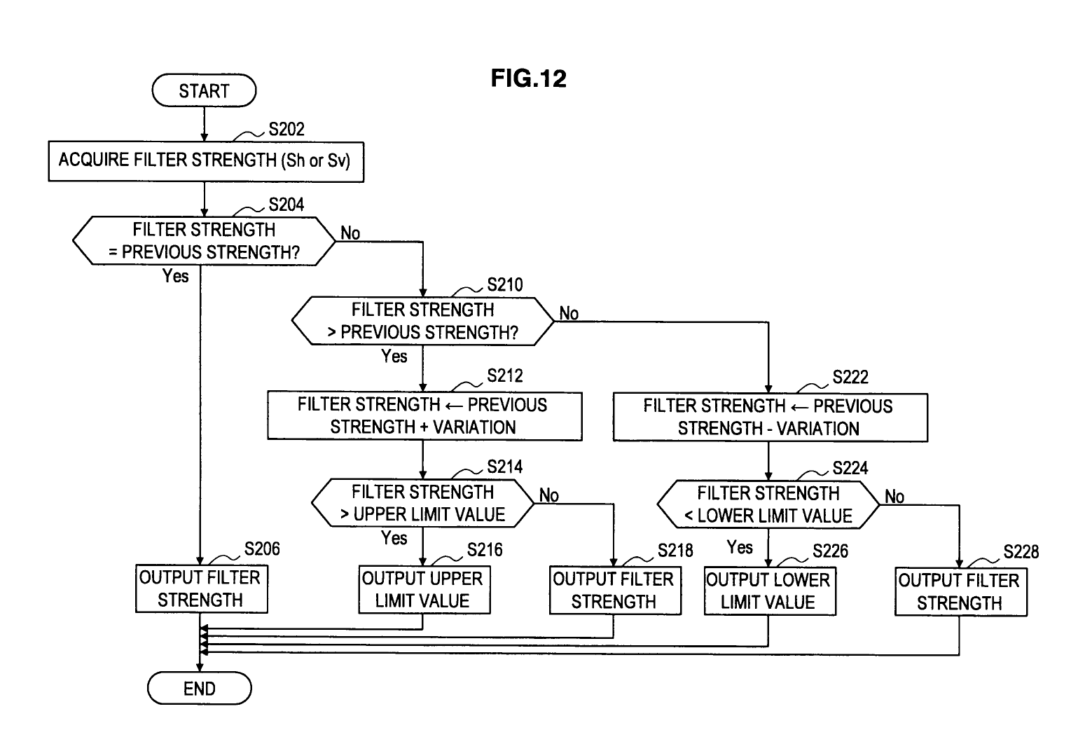

FIG. 12 is a flow chart showing an exemplary flow of the strength step-control process in accordance with this embodiment.

Referring to FIG. 12, the strength step-control unit 147b acquires the filter strength (Sh or Sv) from the strength determination unit 147a (step S202). Next, the strength step-control unit 147b determines if the acquired filter strength is equal to the output value of the previous strength (S204). Herein, if the acquired filter strength is determined to be equal to the output value of the previous strength, the strength step-control unit 147b outputs the filter strength to the parameter output unit 147d (step S206). Meanwhile, if the acquired filter strength is not determined to be equal to the output value of the previous strength, the strength step-control unit 147b further determines if the acquired filter strength is higher than the output value of the previous strength (step S210). Herein, if the acquired filter strength is determined to be higher than the output value of the previous strength, the process proceeds to step S212. Meanwhile, if the acquired filter strength is not determined to be higher than the output value of the previous strength, the process proceeds to step S222.

In step 212, the strength step-control unit 147b substitutes a value, which is obtained by adding a predetermined variation to the output value of the previous strength, into the filter strength (step S212). For example, if the output value of the previous strength is Lv0 and the variation is defined as level 1, the new filter strength is Lv1. Next, the strength step-control unit 147b determines if the new filter strength is above the upper limit value of the filter strength (step S214). Herein, if the new filter strength is determined to be above the upper limit value of the filter strength, the strength step-control unit 147b outputs the upper limit value (e.g., Lv4) of the filter strength to the parameter output unit 147d (step S216). Meanwhile, if the new filter strength is not determined to be above the upper limit value of the filter strength, the strength step-control unit 147b outputs the new filter strength to the parameter output unit 147d (step S218).

In step S222, the strength step-control unit 147b substitutes a value, which is obtained by subtracting a predetermined variation from the output value of the previous strength, into the filter strength (step S222). For example, if the output value of the previous strength is Lv4 and the variation is defined as level 1, the new filter strength is Lv3. Next, the strength step-control unit 147b determines if the new filter strength is below the lower limit value of the filter strength (step S224). Herein, if the new filter strength is determined to be below the lower limit value of the filter strength, the strength step-control unit 147b outputs the lower limit value (e.g., Lv0) of the filter strength to the parameter output unit 147d (step S226). Meanwhile, if the new filter strength is not determined to be below the lower limit of the filter strength, the strength step-control unit 147b outputs the new filter strength to the parameter output unit 147d (step S228).

The aforementioned step-control process of the strength step-control unit 147b is performed in parallel to each of the filter strength Sh of the horizontal direction and the filter strength Sv of the vertical direction.

The parameter output unit 147d acquires from the filter coefficient table 148 a set of filter coefficients that are associated with the filter strengths Sh and Sv input from the strength step-control unit 147b. Then, the parameter output unit 147d outputs the acquired set of filter coefficients to the filtering unit 150.

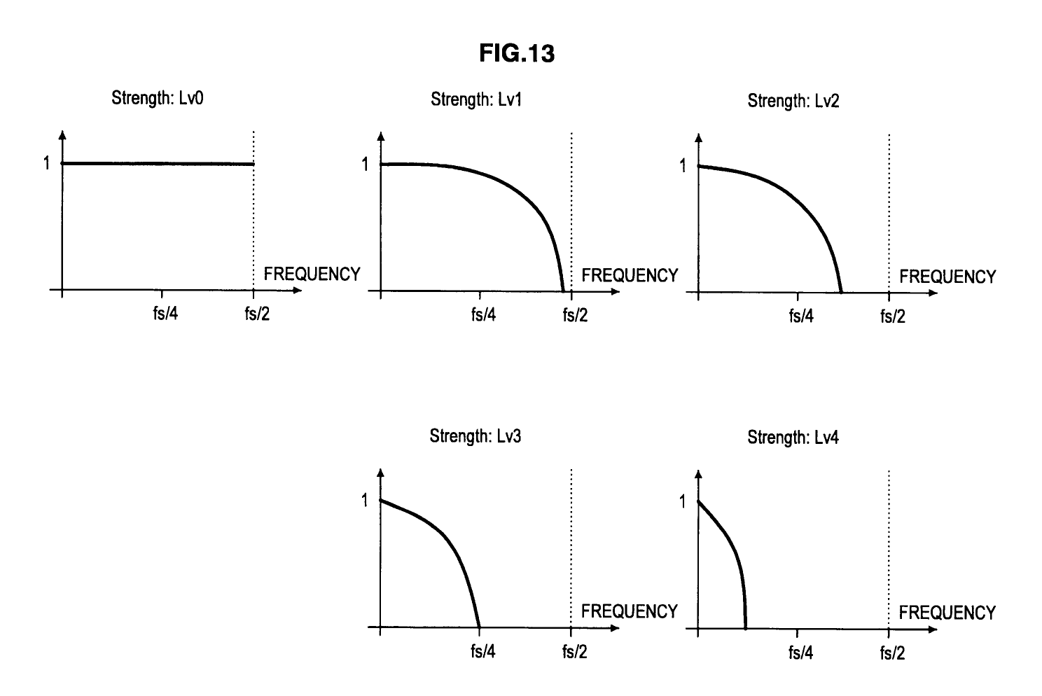

FIG. 13 is an explanatory diagram for illustrating filter coefficients as examples in accordance with this embodiment. The filter coefficient table 148 stores a plurality of predefined filter strengths and a set of filter coefficients corresponding to the respective filter strengths while correlating them with each other. In FIG. 13, filter characteristics defined by a set of filter coefficients corresponding to the respective filter strengths are shown by characteristics graphs.

First, when the filter strength is Lv0 (the upper left graph), the filter characteristics are one over a range of zero to the highest frequency (½ of the sampling rate fs). That is, in this case, the filter passes all signals as they are. When the filter strength is Lv1 to Lv4, the filter characteristics exhibit the characteristics of a low-pass filter. Thus, the higher the filter strength, the higher the attenuation level for high-frequency bands. In addition, the higher the filter strength, the lower the lowest frequency of the blocked bands. For example, when the filter strength is Lv1 (the upper middle graph), signals of only bands that are close to the highest frequency (fs/2) are blocked, whereas signals of bands around fs/4 are hardly attenuated. In contrast, when the filter strength is Lv4 (the lower right graph), signals of wider bands, down to a band that is below the frequency of fs/4, are blocked.

Note that the filter characteristics shown in FIG. 13 are only exemplary. That is, a set of more or fewer types of filter coefficients can be provided, or a set of filter coefficients that exhibit characteristics different from those of FIG. 13 can be provided.

The parameter output unit 147d acquires a set of filter coefficients that exhibit the aforementioned filter characteristics for each of the horizontal direction and the vertical direction, in accordance with the filter strengths input from the strength step-control unit 147b, and outputs the acquired set of filter coefficients to the filtering unit 150.

Note that the filter coefficient table 148 further stores preset values of the shift amount while correlating them with the set of filter coefficients. The preset values of the shift amount are used for the parameter output unit 147d to determine the shift amount as described below.

### (2) Determination of the Shift Amount

In this embodiment, a “shift amount” refers to the number of bits that are shifted by a shift operation executed by the filtering unit 150 to prevent the maximum filter output value from exceeding the output dynamic range. Since lower-order bits of a signal value are removed by a shift operation, if the shift amount is large, the sharpness of a frame could decrease while noise contained in the frame can be removed more.

The noise level step-control unit 147c controls the output value of a noise level such that the noise level changes in a stepwise manner to ease an abrupt change in the shift amount that is determined on the basis of the noise level. For example, the noise level step-control unit 147c modifies (adds or subtracts) the value of the noise level M3 output from the noise measuring unit 118 such that the value of the noise level M3 changes on a frame-by-frame basis by a constant amount. The noise level step-control unit 147c can be implemented by a logical process similar to the strength step-control process shown in FIG. 12, or by using IIR (Infinite Impulse Response).

The parameter output unit 147d refers to the filter coefficient table 148, and acquires an offset of the shift amount that is associated with the noise level input from the noise level step-control unit 147c. Then, the parameter output unit 147d outputs a value, which is obtained by adding the offset of the shift amount to a preset value of the shift amount acquired from the filter coefficient table 148, to the filtering unit 150 as a shift amount to be finally used.

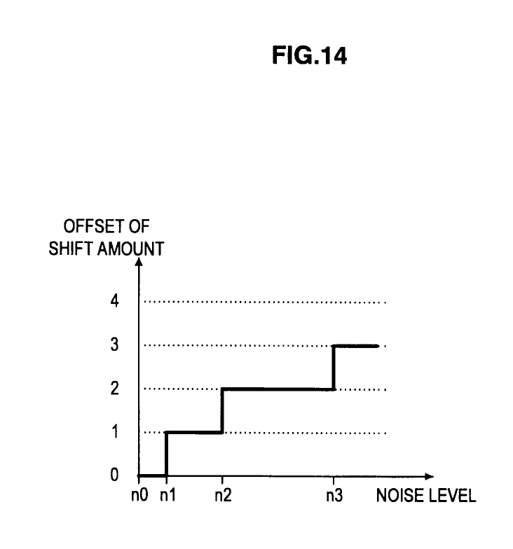

FIG. 14 is an explanatory diagram for illustrating an offset of the shift amount as an example in accordance with this embodiment. The filter coefficient table 148 stores the range of noise level values and an offset of the shift amount corresponding to each noise level while correlating them with each other.

In the example of FIG. 14, the offset of the shift amount is zero when the noise level value is n0 to n1. When the noise level value is n1 to n2, the offset of the shift amount is one. When the noise level value is n2 to n3, the offset of the shift amount is two. When the noise level value is over n3, the offset of the shift amount is three. Note that the values n0, n1, n2, and n3 that define the range of noise levels can be defined in advance with the signal processing device 100 and changed as appropriate in accordance with an input video signal handled by the signal processing device 100.

Provided that the preset value of the shift amount defined in advance with the set of filter coefficients is Sfᵢₙ, the offset of the shift amount acquired according to a noise level is Sf_{offset}, and the shift amount output from the parameter output unit 147d is Sfₒᵤₜ, Sfₒᵤₜ can be given by the following formula.

[Formula 1]

Sfₒᵤₜ=Sfᵢₙ+Sf_{offset} (1)

### [2-4. Filtering Unit]

The filtering unit 150 applies a filter with characteristics, which have been determined by the determination unit 140, to the input video signal Vᵢₙ, thereby generating a motion estimation video signal Vₑₓ.

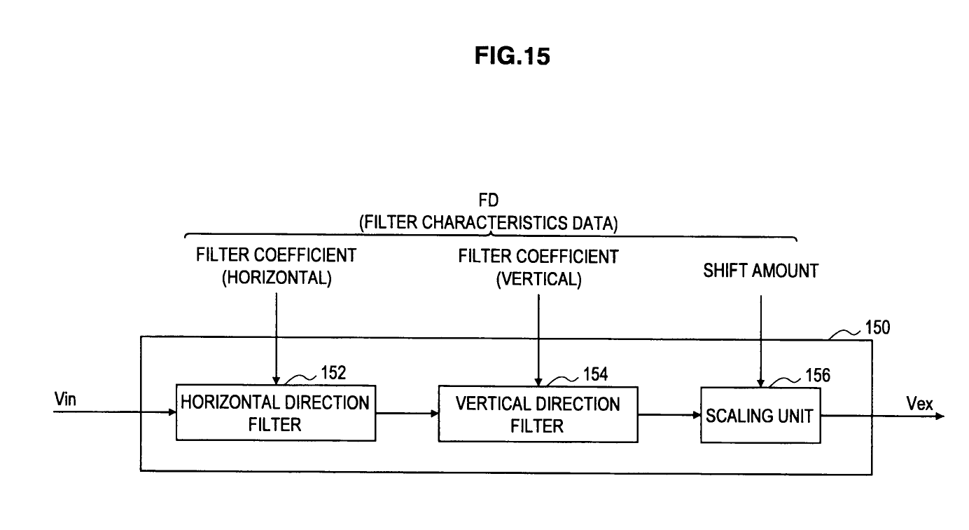

FIG. 15 is a block diagram showing an example of a more detailed configuration of the filtering unit 150 in accordance with this embodiment. Referring to FIG. 15, the filtering unit 150 includes a horizontal direction filter 152, a vertical direction filter 154, and a scaling unit 156. Among the filter characteristics data FD input to the filtering unit 150 from the determination unit 140, the set of filter coefficients for the horizontal direction is input to the horizontal direction filter 152, the set of filter coefficients for the vertical direction is input to the vertical direction filter 154, and the shift amount is input to the scaling unit 156.

The horizontal direction filter 152 filters each frame of the input signal Vᵢₙ using the set of filter coefficients for the horizontal direction, thereby blocking or attenuating high-frequency components in the horizontal direction contained in each frame. The filtering operation performed by the horizontal direction filter 152 is represented by the following formula.

$$\begin{matrix}[ Formula 2 ] & \\ {V}_{hout} [ x , y ] = {\sum }_{i = - M}^{M} {Coeff}_{h} [ i + M ] \cdot {V}_{in} [ x + i , y ] & ( 2 )\end{matrix}$$

Herein, Vᵢₙ[x,y] indicates a pixel value at the coordinates (x,y) of a single frame of the input video signal. M indicates a value that determines the number of filter taps of the horizontal direction filter 152. Coeffₕ[0] to Coeffₕ[2M] indicate a set of filter coefficients for the horizontal direction. Vₕₒᵤₜ[x,y] indicates a pixel value at the coordinates (x,y) of a single frame of the output signal of the horizontal direction filter 152.

The vertical direction filter 154 filters each frame of the output signal Vₕₒᵤₜₜ from the horizontal direction filter 152 using the set of filter coefficients for the vertical direction, thereby blocking or attenuating high-frequency components in the vertical direction contained in each frame. The filtering operation performed by the vertical direction filter 154 is represented by the following formula.

$$\begin{matrix}[ Formula 3 ] & \\ {V}_{vout} [ x , y ] = {\sum }_{j = - N}^{N} {Coeff}_{v} [ j + N ] \cdot {V}_{hout} [ x , y + j ] & ( 3 )\end{matrix}$$

Herein, N is a value that determines the number of filter taps of the vertical direction filter 154. Coeffᵥ[0] to Coeffᵥ[2N] indicate a set of filter coefficients for the vertical direction. Vᵥₒᵤₜ[x,y] indicates a pixel value at the coordinates (x,y) of a single frame of the output signal of the vertical direction filter 154.

The scaling unit 156 shifts the output signal of the vertical direction filter 154 such that the output signal from the filtering unit 150 does not exceed the dynamic range. The shift operation performed by the scaling unit 156 is represented by the following formula.

[Formula 4]

Vₑₓ[x,y]=Vᵥₒᵤₜ[x,y]>>Sfₒᵤₜ (4)

Vₑₓ[x,y] indicates a pixel value at the coordinates (x,y) of a single frame of the motion estimation video signal Vₑₓ output from the filtering unit 150 as a result of the filtering process.

### [2-5. Frame Memory]

The frame memory 160 temporarily stores each frame of the motion estimation video signal Vₑₓ output from the filtering unit 150. Each frame of the motion estimation video signal Vₑₓ stored in the frame memory 160 is used for the motion estimation unit 170 to estimate a motion vector. In addition, the frame memory 160 temporarily stores each frame of the input video signal Vᵢₙ input to the signal processing device 100. Further, the frame memory 160 also temporarily stores a motion vector for each frame estimated by the motion estimation unit 170. Each frame of the input video signal Vᵢₙ and the motion vector for each frame that are stored in the frame memory 160 are used for the interpolation processing unit 180 to interpolate a new frame(s).

### [2-6. Motion Estimation Unit]

The motion estimation unit 170 estimates a motion vector representing a motion that appears in each frame on the basis of the signal correlation between a first frame and a second frame of the motion estimation video signal Vₑₓ generated by the filtering unit 150. The first frame and the second frame correspond to, for example, the current (latest) frame and the previous frame. Estimation of a motion vector by the motion estimation unit 170 can be performed with a known method such as a block matching method. Then, the motion estimation unit 170 outputs the estimated motion vector to the interpolation processing unit 180.

### [2-7. Interpolation Processing Unit]

The interpolation processing unit 180 interpolates a new frame(s) between the first frame and the second frame of the input video signal Vᵢₙ in accordance with a motion estimated by the motion estimation unit 170, namely, the motion vector input from the motion estimation unit 170. Interpolation of a frame(s) by the interpolation processing unit 180 can also be performed with a known method. Then, the interpolation processing unit 180 outputs an output video signal Vₒᵤₜ with the interpolated frame(s). The output video signal Vₒᵤₜ can be used either directly as a frame-rate-converted video signal or for applications such as interlace-to-progressive conversion.

### <3. Description of the Advantageous Effects>

The signal processing device 100 in accordance with one embodiment of the present invention has been described in detail with reference to FIG. 1 to FIG. 15. According to this embodiment, the characteristics of a filter to be applied to an input video signal are determined on the basis of the measured values for feature quantities that have an influence on an estimation of a motion that appears in each frame of the input video signal. The filter with the thus determined characteristics is applied to the input video signal. Then, a video signal generated as a result of the filtering process is used to estimate a motion. According to such a configuration, the characteristics of a filter for generating a video signal for motion estimation are controlled dynamically. Thus, if an input video signal contains repetitive patterns or strong noise, such influence can be effectively reduced. Meanwhile, if an input video signal does not contain repetitive patterns or strong noise, the strength of the filer to be applied to the input video signal is suppressed. Thus, it is possible to provide a video signal, from which a motion that appears in each frame of an input video signal can be estimated with high robustness. In addition, according to this embodiment, the video signal for motion estimation is provided separately from a video signal that is input for a subsequent process such as frame interpolation. Thus, even when a strong filter is used to reduce vector errors in motion vectors, there is no possibility that the filtering process may influence the image quality of an output video.

In addition, according to this embodiment, feature quantities that have an influence on an estimation of a motion include a feature quantity depending on the amplitude of high-frequency components in the horizontal direction or the vertical direction of each frame of an input video signal. That is, using the amplitude of the high-frequency components in the horizontal direction or the vertical direction (or both) as the basis for the determination of the filter characteristics makes it possible to identify the intensity of a repetitive pattern that appears in the input frame and to select filter characteristics that will allow such repetitive pattern to be removed or eased. The feature quantity depending on the amplitude of high-frequency components is, for example, a histogram per band of the horizontal direction or the vertical direction of each frame of an input video signal. Using the histogram per band allows sorting of the amplitudes of the high-frequency components into a plurality of levels according to the number of bands. Thus, the filter characteristics can be controlled more flexibly. Another example of the feature quantity depending on the amplitude of high-frequency components is a sum of the differences between the pixel values of adjacent pixels that are contained in each frame of an input video signal. Determining the sum of the differences between the pixel values of the adjacent pixels would not require a complex calculation process. Thus, such a sum can be determined with a low calculation cost and a relative small circuit size.

Further, according to this embodiment, the feature quantities that have an influence on an estimation of a motion include a noise level that represents the intensity of noise components contained in each frame of an input video signal. For example, if a shift amount as one of the filter characteristics is determined in accordance with the noise level, it is possible to, when the noise level is low, maintain the sharpness of the frame, and, when the noise level is high, remove the noise. Accordingly, robustness of the motion vector estimation can be further improved.

### <4. Variation>

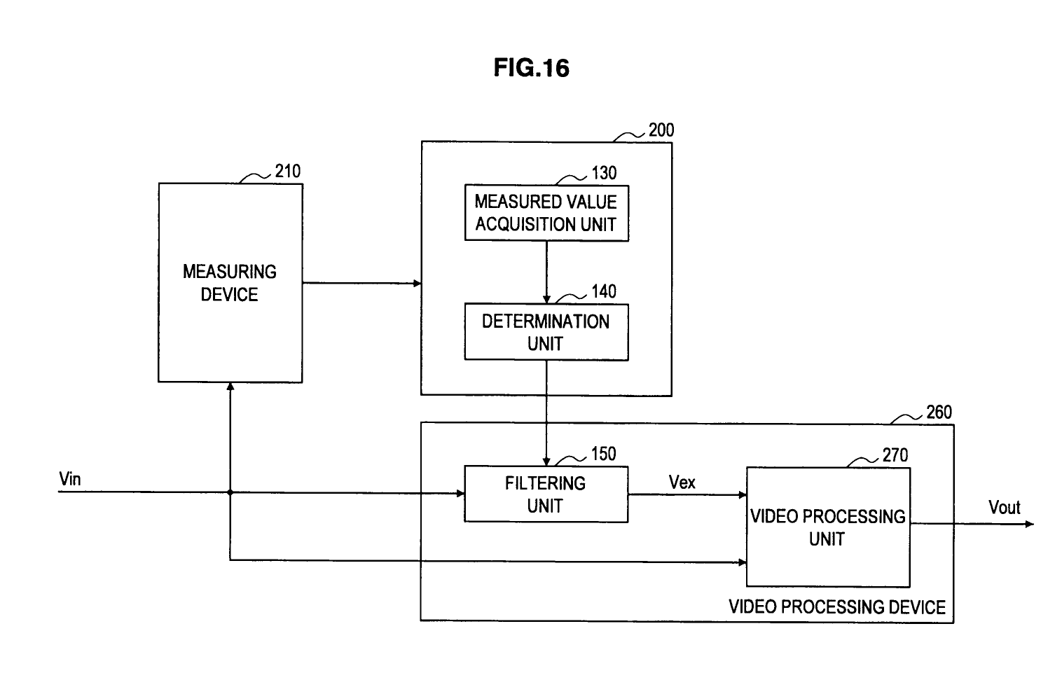

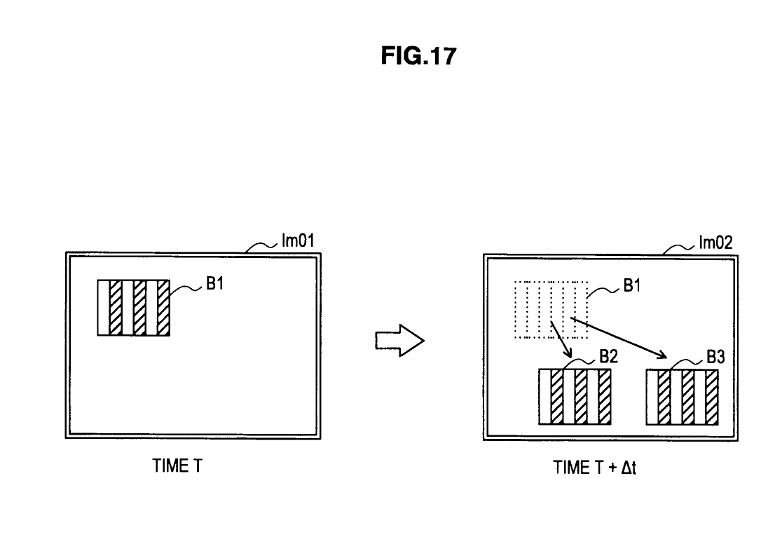

The aforementioned embodiment has illustrated an example in which the signal processing device 100 includes the measuring unit 110, the motion estimation unit 170, and the interpolation processing unit 180. However, the present invention is not limited thereto. For example, a device can be provided that includes only the aforementioned measured value acquisition unit 130, determination unit 140, and filtering unit 150; or only the measured value acquisition unit 130 and the determination unit 140. For example, a signal processing device 200 in accordance with one variation shown in FIG. 16 includes only the measured value acquisition unit 130 and the determination unit 140. In this case, the signal processing device 200 is connected to a measuring device 210 that has about an equal function to the aforementioned measuring unit 110. The measured value acquisition unit 130 of the signal processing device 200 acquires from the measuring device 210 measured values for feature quantities that have an influence on an estimation of a motion that appears in each frame of an input video signal. The signal processing device 200 is also connected to a video processing device 260. Then, the determination unit 140 of the signal processing device 200, on the basis of the measured values acquired by the measured value acquisition unit 130, determines the characteristics of a filter to be applied to the input video signal Vᵢₙ, and informs the filtering unit 150 of the video processing device 260 of the thus determined filter characteristics. The filtering unit 150 of the video processing device 260 applies a filter with the informed characteristics to the input video signal Vᵢₙ to thereby generate a motion estimation video signal Vₑₓ, and then outputs the thus generated motion estimation video signal Vₑₓ to the video processing unit 270. The video processing unit 270 estimates a motion vector using the motion estimation video signal Vₑₓ, and outputs an output video signal Vₒᵤₜ that is obtained by, for example, interpolating a new frame(s) to the input video signal Vᵢₙ.

The signal processing device 100 or 200 need not use one or more of the aforementioned three types of the measured values: M1, M2, and M3 for the determination of the filter characteristics. For example, if the adjacent difference sum M2 is not used, the characteristics determination unit 146 of the measuring unit 140 can determine the filter characteristics on the basis of only the filter strengths S1hₜₘₚ and S1hᵥₘₚ input from the first determination unit 142. Likewise, if the histogram per band M1 is not used, the characteristics determination unit 146 of the determination unit 140 can determine the filter characteristics on the basis of only the filter strengths S2hₜₘₚ and S2hᵥₘₚ input from the second determination unit 144. Further, the signal processing device 100 or 200 need not determine the filter characteristics or perform the filtering process for one of the horizontal direction and the vertical direction.

Note that some or all of a series of the processes performed by the signal processing devices 100 and 200 described in this specification can be implemented with software. A program that constitutes such software for implementing some or all of the series of processes is stored in advance in a storage medium that is provided in or outside of the device. Each program is, when executed, read into RAM and executed by a processor such as a CPU.

Although the preferred embodiments of the present invention have been described in detail with reference to the appended drawings, the present invention is not limited thereto. It is obvious to those skilled in the art that various modifications or variations are possible insofar as they are within the technical scope of the appended claims or the equivalents thereof. It should be understood that such modifications or variations are also within the technical scope of the present invention.

The present application contains subject matter related to that disclosed in Japanese Priority Patent Application JP 2010-112273 filed in the Japan Patent Office on May 14, 2010, the entire content of which is hereby incorporated by reference.

What is claimed is:

1. A signal processing device comprising:
a measured value acquisition unit configured to acquire a measured value for a feature quantity, the feature quantity having an influence on an estimation of a motion that appears in each frame of an input video signal;
a determination unit configured to, on the basis of the measured value acquired by the measured value acquisition unit, determine a characteristic of a filter to be applied to the input video signal; and
a filtering unit configured to generate a video signal for use in the estimation of a motion by applying to the input video signal a filter with the characteristic determined by the determination unit.

2. The signal processing device according to claim 1, wherein the feature quantity having an influence on the estimation of a motion includes a feature quantity depending on an amplitude of a high-frequency component in a horizontal direction or a vertical direction of each frame of the input video signal.

3. The signal processing device according to claim 2, wherein the feature quantity depending on the amplitude of the high-frequency component includes a first feature quantity representing a histogram per band of the horizontal direction or the vertical direction of each frame of the input video signal.

4. The signal processing device according to claim 2, wherein the feature quantity depending on the amplitude of the high-frequency component includes a second feature quantity representing a sum of differences between pixel values of adjacent pixels that are contained in each frame of the input video signal.

5. The signal processing device according to claim 2, wherein the determination unit changes an attenuation level for a high-frequency band as the characteristic of the filter in accordance with the amplitude of the high-frequency component in each frame of the input video signal, the amplitude being indicated by the measured value acquired by the measured value acquisition unit.

6. The signal processing device according to claim 3, wherein the determination unit changes a blocked band as the characteristic of the filter in accordance with a frequency of a band that indicates the maximum frequence in the histogram per band.

7. The signal processing device according to claim 1, wherein the feature quantity having an influence on the estimation of a motion includes a third feature quantity depending on an intensity of a noise component contained in each frame of the input video signal.

8. The signal processing device according to claim 7, wherein
the characteristic of the filter is represented by a filter coefficient to be multiplied by each signal value of the input video signal, and a shift amount for each signal value, and
the determination unit changes the shift amount in accordance with the intensity of the noise component in each frame of the input video signal, the intensity being indicated by the measured value acquired by the measured value acquisition unit.

9. The signal processing device according to claim 1, further comprising a measuring unit configured to measure the feature quantity for each frame of the input video signal.

10. The signal processing device according to claim 1, further comprising a motion estimation unit configured to estimate a motion that appears in each frame on the basis of a signal correlation between a first frame and a second frame of the video signal generated by the filtering unit.

11. The signal processing device according to claim 10, further comprising an interpolation processing unit configured to interpolate another frame between the first frame and the second frame of the input video signal in accordance with a motion estimated by the motion estimation unit.

12. A signal processing method for processing an input video signal with a signal processing device, the method comprising the steps of:
acquiring a measured value for a feature quantity, the feature quantity having an influence on an estimation of a motion that appears in each frame of the input video signal;
determining a characteristic of a filter to be applied to the input video signal on the basis of the acquired measured value; and
generating a video signal for use in the estimation of a motion by applying to the input video signal a filter with the determined characteristic.
